(19) United States
(12) Patent Application Publication
(10) Pub. No.: US 2008/0084041 A1
(43) Pub. Date: Apr. 10, 2008

(54) Receptacle dolly

(76) Inventor: Stephen A. Dukes, North Baltimore, OH (US)

Correspondence Address: FRASER CLEMENS MARTIN & MILLER LLC, 28366 KENSINGTON LANE, PERRYSBURG, OH, 43551, US

(21) Appl. No.: 11/543,514

(22) Filed: Oct. 5, 2006

(51) Int. Cl. B62B 5/00

(52) U.S. Cl. 280/79.5

(57) ABSTRACT

A dolly is disclosed for supporting and transporting an associated receptacle. The dolly has an upper surface and a spaced apart lower surface. The upper surface includes means for selectively attaching a receptacle and the lower surface includes means for attaching a plurality of ground engaging wheels depending from the lower surface.

### FIELD OF THE INVENTION

The present invention relates to a dolly used to support and transport an associated receptacle. More particularly, the invention is directed to a dolly that is selectively connectable to an associated receptacle.

### BACKGROUND OF THE INVENTION

The use of a specially adapted dolly for securing and transporting an associated receptacle is well known in the prior art. U.S. Pat. No. 5,074,572 and Design U.S. Pat. Nos. 349,995 and 328,172 are exemplary of dolly structures incorporating the features of the prior art.

The prior art structures provide an easily transportable receptacle which can be maintained in close proximity to the work site. The mobility of the receptacle increases efficiency by saving the time that would otherwise be used in continually traversing the distance between the work site and the receptacle location.

An additional benefit realized is the safety provided to a person using the dolly. The dolly supports the weight of the receptacle and eliminates much of the physical exertion that would otherwise be expended to move the receptacle, as is especially significant once the receptacle is full and heavy. The risk of injury to the back, wrists, shoulders, and other body parts of the user is greatly reduced by lowering the level of physical exertion required to move the receptacle.

There are some shortcomings to the current dolly designs. The shortcomings primarily concern the safe use of the dolly and the dolly receptacle assembly. The dolly wheels are one area of safety concern with the current dolly designs. The point of contact between the ground and the dolly wheels is a pinch point for feet and toes. The prior art dolly wheels are typically fully exposed which allow a foot or toe to be pinched between the ground and dolly wheel resulting in an injury, especially if the dolly were heavily loaded.

Another safety concern with the current dolly designs involves the process of attaching or detaching a receptacle to the dolly. The prior art devices require a significant amount of dexterity to complete the process of attaching or detaching a receptacle since a number of simultaneous body movements must be coordinated. The dolly, which is designed to freely roll, must be held stationary while the receptacle is being attached or detached. For example, the user of the dolly must use his feet to secure the dolly while using his upper body to position and attach the receptacle to the dolly. If the foot of the user slips from holding the dolly stationary, the user may injure his body due to a sudden over stretching or sustain other injuries if he loses his balance and falls.

Some users of the prior art devices have attempted to mitigate these hazards by first lifting the associated receptacle, turning it upside-down, and placing the open end on the ground; lifting the dolly, turning it upside-down, and attaching it to the inverted receptacle; and finally picking up the assembly, turning it right side-up, and placing it back on the ground. This process can be performed in the reverse order to detach the dolly from the receptacle. The required lifting and turning in this multi-step alternative method of attaching or detaching the receptacle still exposes the user to bodily injury. Further, this method subjects the user to coming in contact with any accumulated dirt on the dolly and the receptacle and will spill any material remaining in the receptacle.

The dolly receptacle assembly is also a source of safety concerns. Many of the prior art assemblies use a screw thread to attach the receptacle to the dolly. During the normal use of the assembly, the receptacle is typically subjected to conditions that result in a relative rotational movement between the receptacle and the dolly which loosens the attachment of the receptacle to the dolly. If the receptacle loosens from the dolly to the point where it surprisingly detaches from the dolly, the user of the dolly could be injured and the contents of the receptacle will spill.

Lastly, many of the prior art dolly and receptacle assemblies feature a dolly with outer dimensions that are substantially the same as the bottom surface of the receptacle. This results in the dolly wheels being positioned inwardly of the outer perimeter of the receptacle bottom surface. This positioning of the wheels with respect to the receptacle provides for a small supporting base resulting in a reduction in the overall stability of the assembly. The reduction in stability is a safety concern for both the user of the dolly and others in the vicinity of the tipping dolly and resultant spill. Even in the event the dolly were to tip and no injury resulted, there would still be the general inconvenience with the associated clean up.

It would be desirable to have a dolly for supporting and transporting an attached receptacle which would prevent the feet and toes of the user from coming into contact with the dolly wheels, lend itself to being safely held stationary during the attachment and detachment of a receptacle, provide for the secure attachment of the receptacle, and resist tipping.

### SUMMARY OF THE INVENTION

Harmonious with the present invention, it is an object of the invention to produce a dolly for supporting and transporting an attached receptacle that prevents the feet and toes of the user from coming into contact with the dolly wheels.

Another objective of the invention is to produce a dolly that may be safely held stationary during the attachment and detachment of a receptacle.

Another objective of the invention is to produce a dolly that may be securely attached to an associated receptacle.

Still another objective of the invention is to produce a dolly that readily remains upright during use.

Surprisingly, the above objectives and advantages of the invention may typically be achieved by a dolly comprising a connection means disposed on the upper surface of the dolly for engagement with the attachment means of a receptacle, a plurality of ground engaging wheels depending from the lower surface of the dolly, and contact means integral with the dolly engagable by the user to hold the dolly stationary to facilitate attachment of the dolly and the receptacle.

### BRIEF DESCRIPTION OF THE DRAWINGS

The following detailed description of the present invention can be best understood when read in conjunction with the following drawings, wherein like structures are indicated with like reference numerals and in which:

FIG. 1 is a perspective view of a dolly embodying the features of the present invention;

FIG. 2 is a perspective view of the lower surface of the dolly illustrated in FIG. 1;

FIG. 3 is an elevational view thereof;

FIG. 4 is a top view thereof;

FIG. 5 is a bottom view thereof;

FIG. 6 is a perspective view an alternative embodiment of the present invention;

FIG. 7 is a perspective view of the lower surface of the dolly illustrated in FIG. 6;

FIG. 8 is a perspective view of another embodiment of the present invention;

FIG. 9 is a perspective view of still another embodiment of the present invention;

FIG. 10 is a perspective view of still another embodiment of the present invention;

FIG. 11 is a perspective view of a dolly and an attached receptacle embodying the features of the present invention; and

FIG. 12 is a sectional view of FIG. 11 taken along line A-A.

### DETAILED DESCRIPTION OF THE PREFERRED EMBODIMENTS

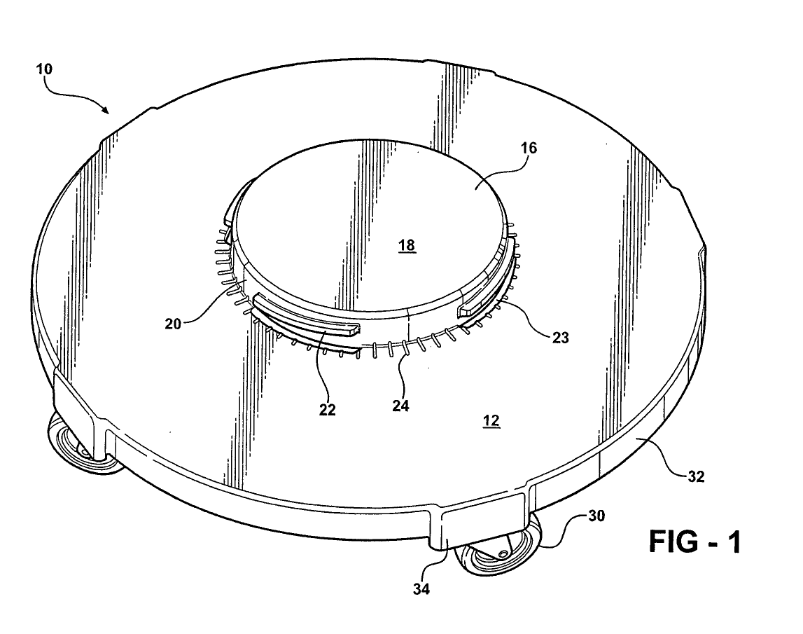

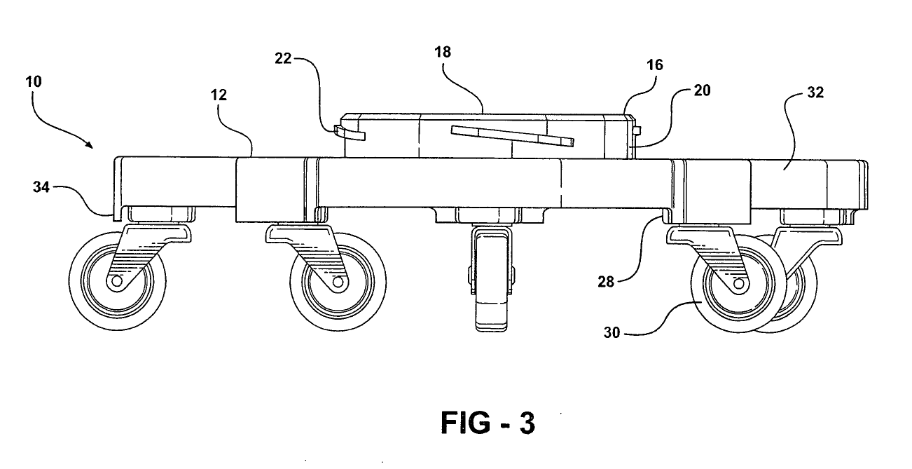

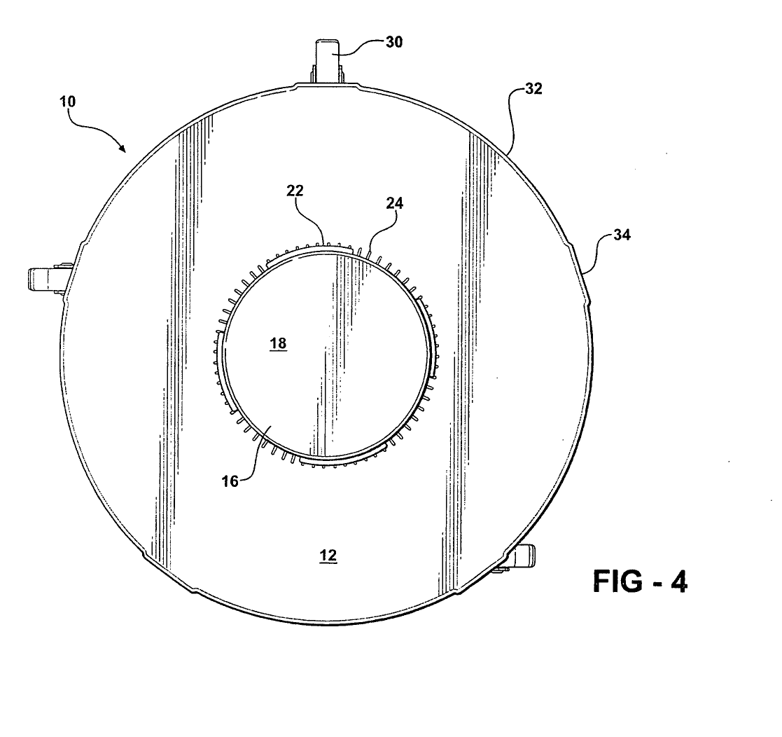

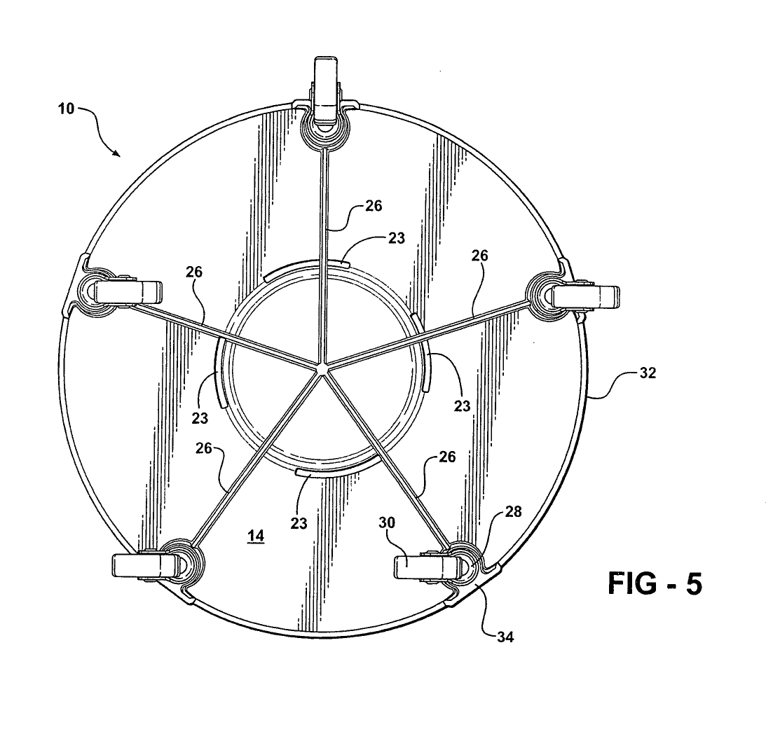

Referring now to the drawings and particularly to FIGS. 1 through 5 the preferred embodiment of a dolly is illustrated embodying the features of the present invention. The dolly, generally indicated by reference numeral 10, is disk shaped and includes an upper planar surface 12 and a spaced apart generally coextensive lower surface 14. It is understood that the dolly 10 could be of different shapes without departing from the scope and spirit of the invention. The upper surface 12 and lower surface 14 are superposed and have a common outer periphery. The upper surface 12 is typically planar and includes a centrally disposed upwardly extending cylindrical boss 16 having an upper planar surface 18.

An outer radial skirt 20 depends downwardly from the upper surface 18 connecting the surfaces 12 and 18 of the dolly 10. Annually spaced apart threads 22 are formed integral with and extend radially outwardly from the surface 20. There are slots 23 through surface 12 that are superposed and coextensive with the respective threads 22. An annular array of radially outwardly extending locking tabs 24 are formed on the lower portion of surface 20 and the adjacent surface 12. The threads 20 and locking tabs 24 are adapted to selectively engage cooperating means on the bottom surface of an associated receptacle.

The illustrations make it clear that the upper surface 12 does not include any apertures formed therein. An aperture is a collection point for debris. The absence of such apertures results in a dolly 10 that stays clean for a longer period of time and is easily swept or wiped clean when it becomes necessary to do so.

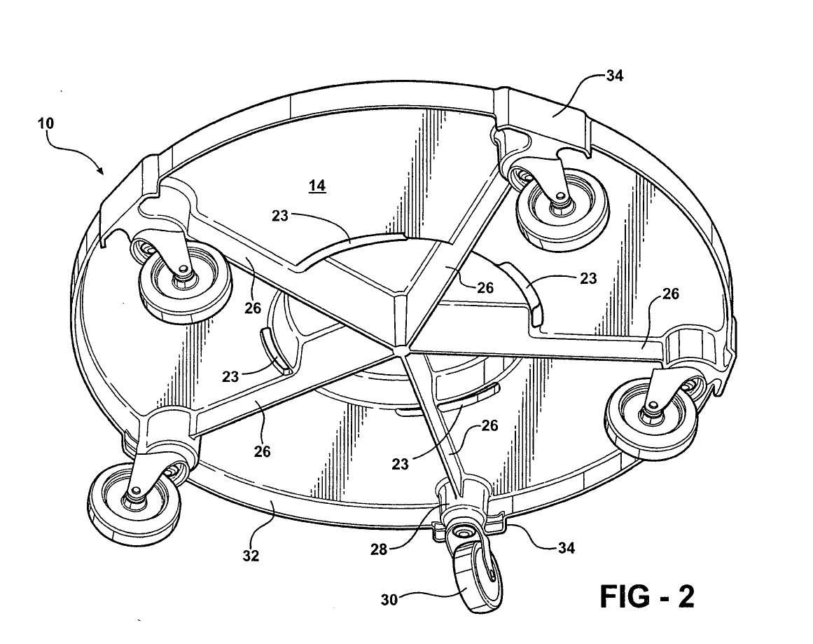

The lower surface 14, as is clearly illustrated in FIG. 2, includes a plurality of radially extending structural reinforcing ribs 26 which depend from the lower surface 14. Spaced apart attachment means 28 are formed to depend downwardly from the lower surface 14 and are adapted to receive respective ground engaging caster wheels 30 which depend from the outer periphery of the dolly 10. A skirt 32 depends downwardly from the lower surface 14 and is provided with outward extensions 34 adjacent each of the wheels 30.

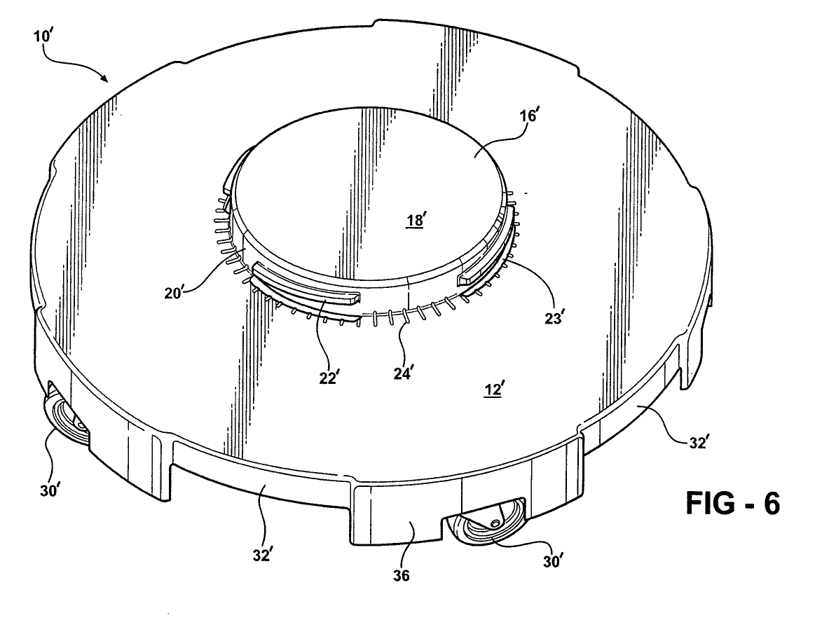

The remaining FIGS. 6-12, inclusive, illustrate embodiments of the invention illustrated in FIGS. 1-5. Where similar components are utilized, prime reference numerals will indicate such components.

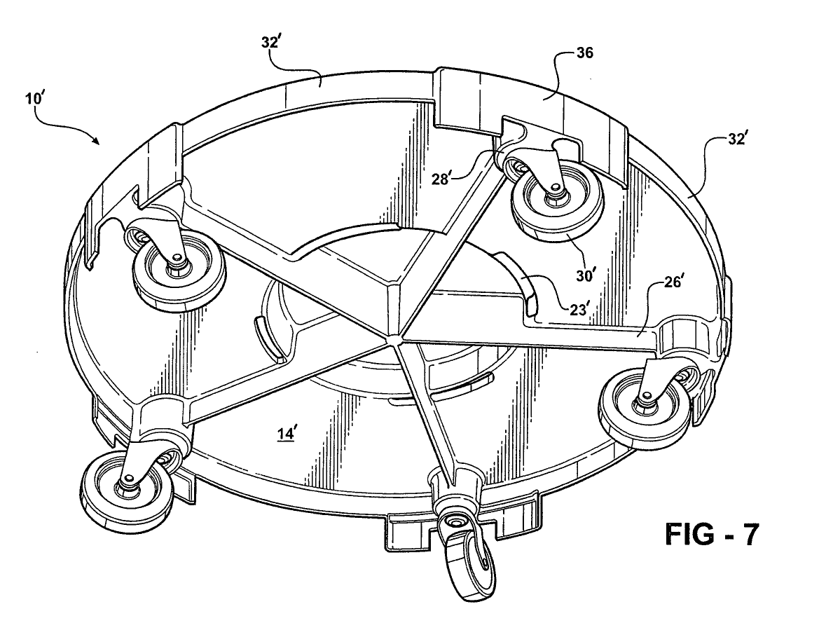

In FIGS. 6 and 7 an alternative embodiment of the structure is illustrated, wherein the skirt 32′ is provided with spaced apart outward extensions 36 located adjacent each of the respective wheels 30′. The outward extension 36 is caused to extend downwardly in the area adjacent the respective wheels 30″.

The skirt 32 and associated outward extensions 34, 36 illustrated in FIGS. 1-5 and FIGS. 6-7 respectively protect the user of the dolly from injury. The point of contact between the ground and wheels 30 is a pinch point for the feet and toes of the user. The skirt 32 and extensions 34, 36 form a shield around the respective wheels 30 and reduce the likelihood that a foot or toe will come in contact with the pinch point.

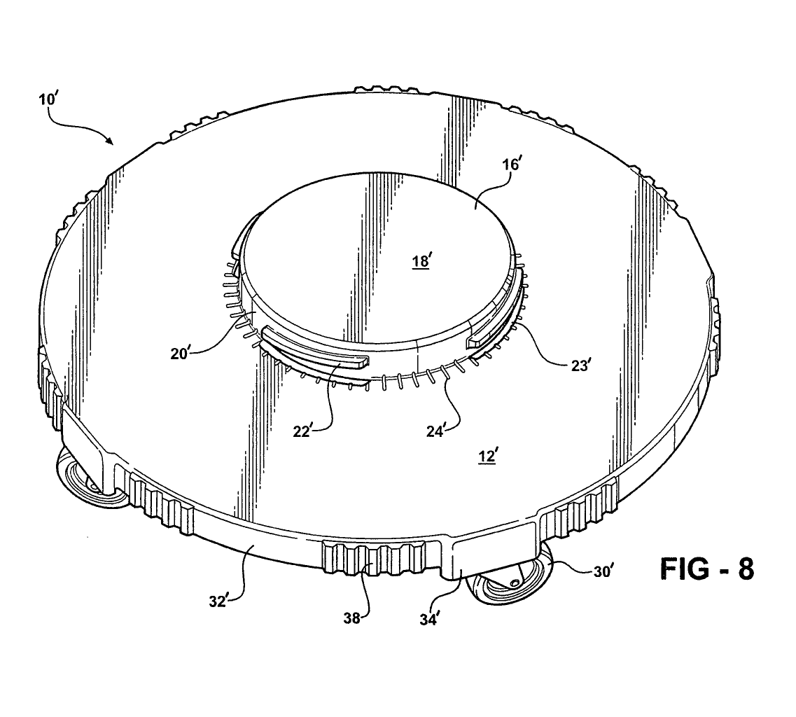

In FIG. 8 another alternative embodiment of the structure is illustrated, wherein the skirt 32′ is provided with a plurality of spaced apart ribs 38. The ribs 38 provide areas of high coefficient of friction which function to assist in holding the dolly 10′ stationary when the shoe of the user is forced against the ribs 38.

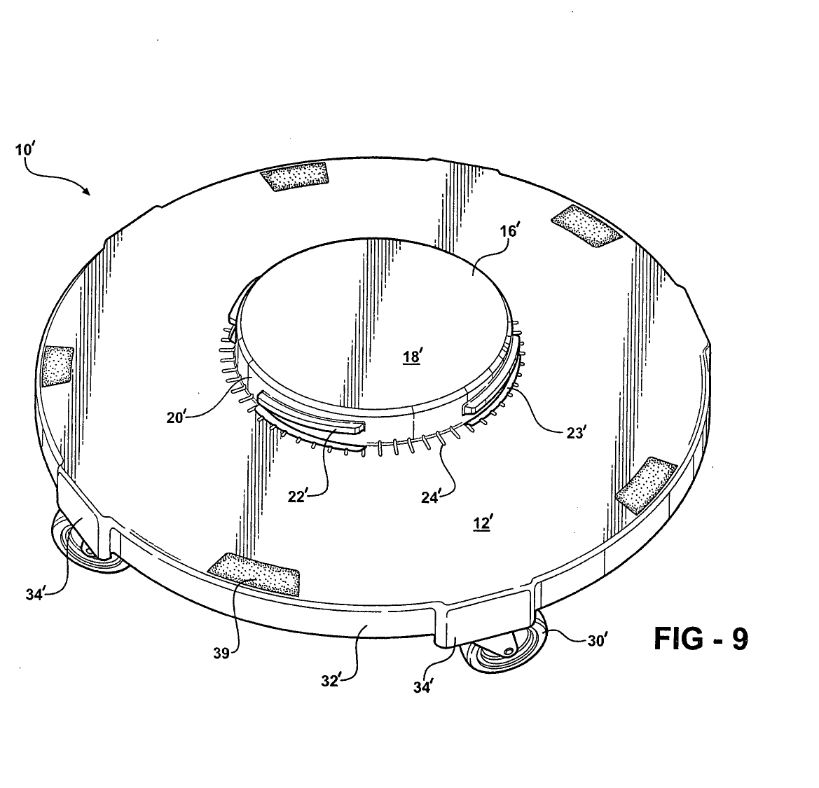

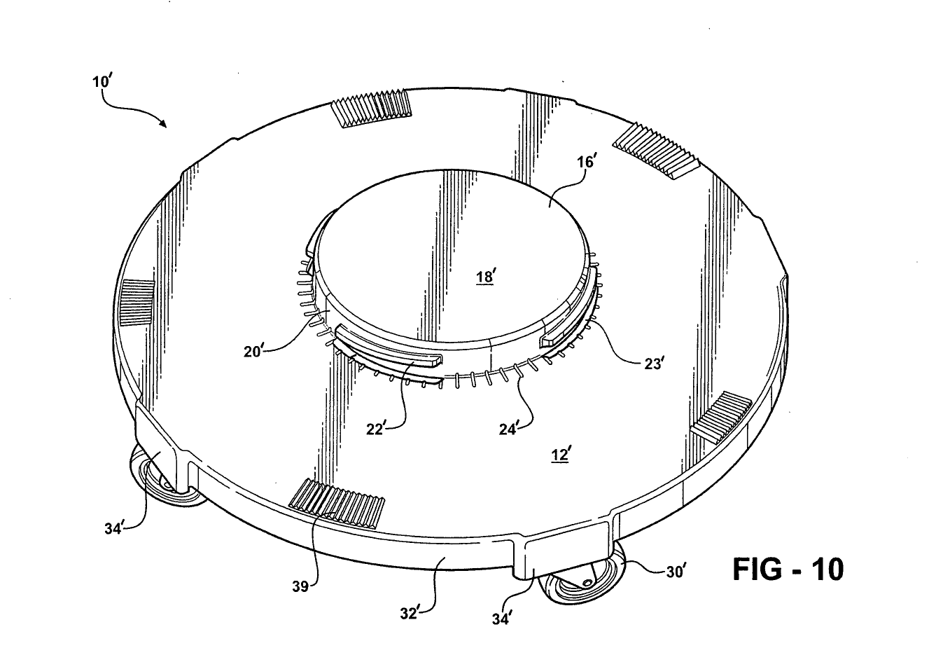

In FIGS. 9-10 still another alternative embodiment of the structure is illustrated, wherein the upper surface 12′ is provided with a plurality of spaced apart high coefficient of friction surfaces 39 adjacent the outer periphery of the dolly 10. The high coefficient of friction surfaces 39 function to assist in holding the dolly stationary when the shoe of the user is forced against the friction surfaces 39.

The shape, spacing, and extent of the ribs 38 and friction surfaces 39 show in FIGS. 8-10 illustrate a sample of the infinite number of rib and frictional surface configurations that could be used. The ribs 38 could be expanded to cover a greater portion or even all of the skirt 32′. Likewise, the frictional surfaces 39 could be expanded to cover a greater portion or even the entire upper surface 12′ of the dolly 10′. Further, the ribs 38 and frictional surfaces 39 could be combined on the same dolly 10′. Such an arrangement would allow the frictional surfaces 39 to be engaged when smaller receptacles are attached to the dolly 10′ which leave the outer periphery of the upper surface 12′ accessible and allow the ribs 38 to be engaged when larger receptacles are attached that completely cover the upper surface 12′.

Additionally, the outward extension 36 illustrated in FIGS. 6 and 7 could be combined with the ribs 38 and frictional surfaces 39 illustrated in FIGS. 8-10. Such a dolly would both protects the feet and toes of the user from injury and facilitate maintaining the dolly stationary by the user.

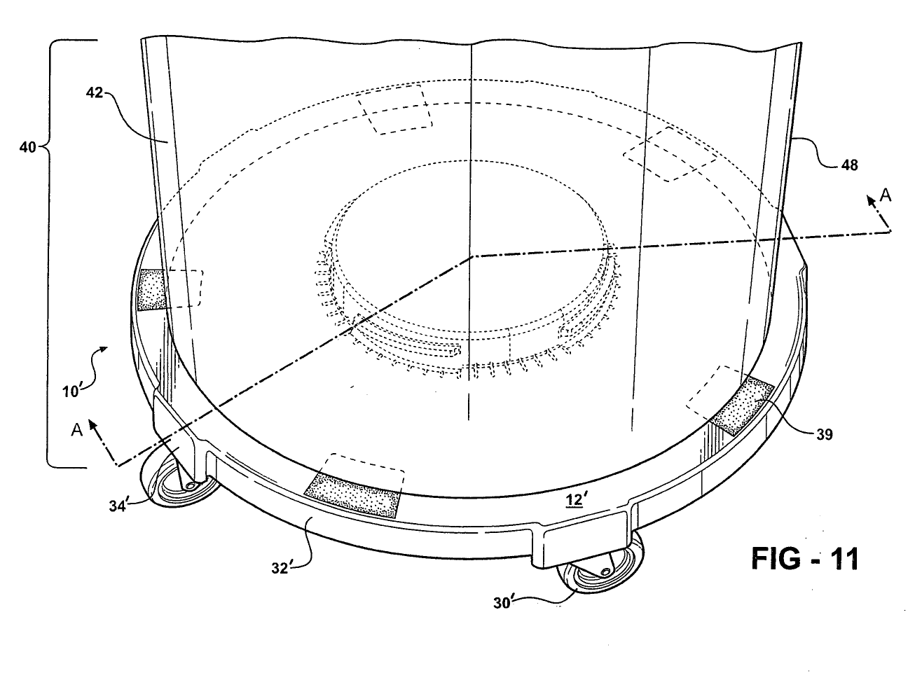

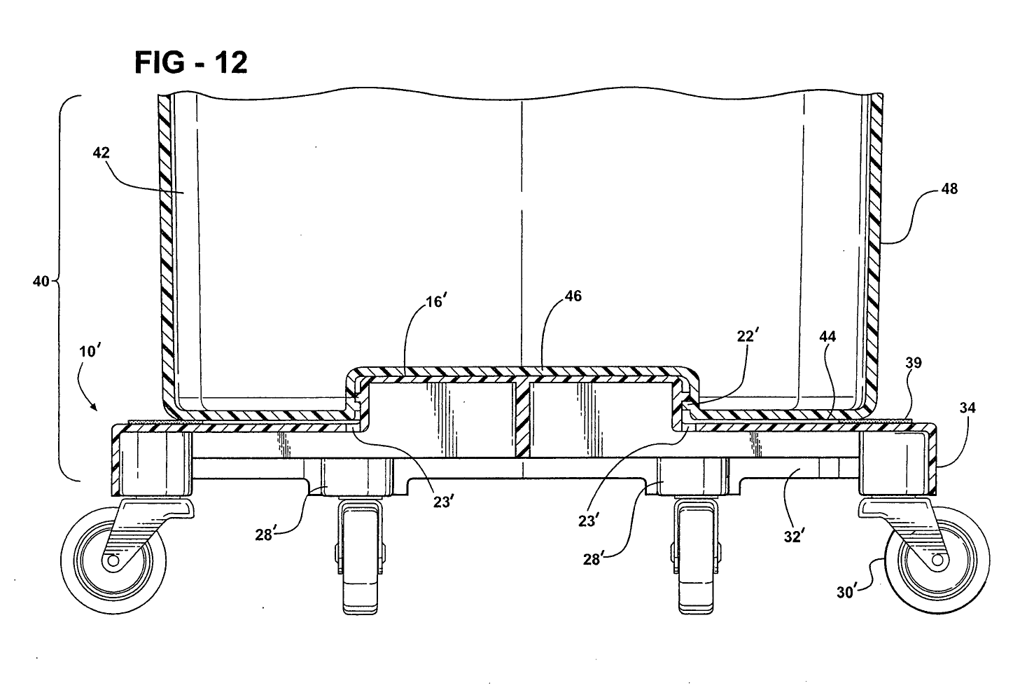

In FIGS. 11 and 12 the dolly 10′ is illustrated with an attached receptacle 42, generally referred to as a container assembly 40. The receptacle 42 has a bottom surface 44 provided with a centrally disposed internally threaded attachment means 46 on the underside thereof. Sidewalls 48 of the receptacle 42 extend upwardly from the bottom surface 44 and terminate in an upper rim (not shown). The internally threaded attachment means 46 is adapted to receive and engage the respective threads 22′ of the boss 16′. It is obvious that the boss 16′ and attachment means 46 could be provided with other shapes and engagement means.

In FIGS. 11 and 12 the friction surfaces 39 on the upper surface 12′ of the dolly 10′ are in contact with the bottom surface 44 of the receptacle 42. The contact friction between the two surfaces 39′, 44 militates against relative rotational movement between the dolly 10′ and the receptacle 42 which assists in maintaining the receptacle 42 securely attached to the dolly 10′ during normal use of the container assembly 40.

It will be noted that the dolly 10′ is wider than the bottom surface 44 of the receptacle 42. Also, the wheels 30′ are positioned outwardly of the bottom surface 44. The disposition of the wheels 30′ with respect to the attached receptacle 42 provide a wide secure base to facilitate the maintenance of the container assembly 40 upright during use.

From the foregoing description, one ordinarily skilled in the art can easily ascertain the essential characteristics of the invention, and can make various changes and modifications to the invention without departing from the spirit and scope thereof.

What is claimed is:

1. A transportable dolly for supporting and transporting an associated receptacle wherein the dolly is provided with an upper surface and a spaced apart lower surface and the receptacle is provided with cooperating attachment means on the underside thereof, the improvement comprising:
connection means disposed on the upper surface of the dolly for engagement with the attachment means of the receptacle;
a plurality of ground engaging wheels depending from the lower surface of the dolly; and
contact means integral with the dolly engagable by a user to hold the dolly stationary to facilitate attachment of the dolly and the receptacle.

2. The dolly according to claim 1, wherein the contact means includes a skirt depending downwardly from the lower surface of the dolly.

3. The dolly according to claim 2, wherein the skirt extends over the ground engaging wheels.

4. The dolly according to claim 3, wherein the skirt includes an outer surface.

5. The dolly according to claim 4, wherein the contact means includes a high coefficient of friction surface disposed on the outer surface of the skirt.

6. The dolly according to claim 5, wherein the high coefficient of friction surface includes undulations.

7. The dolly according to claim 5, wherein the high coefficient of friction surface includes spaced apart ribs.

8. The dolly according to claim 1, wherein the contact means includes a high coefficient of friction surface disposed on the upper surface.

9. The dolly according to claim 8, wherein the high coefficient of friction surface includes undulations.

10. The dolly according to claim 8, wherein the area of high coefficient of friction surface includes spaced apart ribs.

11. A transportable container assembly including a dolly having an upper surface and a spaced apart lower surface and a receptacle having a bottom surface provided with cooperating attachment means on the underside thereof and sidewalls extending from the bottom surface to an upper rim, the improvement comprising:
connection means disposed on the upper surface of the dolly;
a plurality of ground engaging wheels depending from the lower surface of the dolly; and
contact means integral with the dolly engagable by a user to hold the dolly stationary to facilitate attachment of the dolly and the receptacle.

12. The dolly according to claim 11, wherein dolly upper surface includes means to militate against relative rotational movement between the dolly and the receptacle.

13. The dolly according to claim 12, wherein the means to militate against relative rotational movement includes a high coefficient of friction surface.

14. The dolly according to claim 13, wherein the high coefficient of friction surface includes undulations.

15. The dolly according to claim 13, wherein the high coefficient of friction surface includes spaced apart ribs.

16. The assembly according to claim 11, wherein the dolly upper surface and spaced apart lower surface are superposed and have a common outer periphery.

17. The assembly according to claim 16, wherein the outer periphery extends outwardly beyond the bottom surface of the receptacle.

18. The assembly according to claim 17, wherein the ground engaging wheels are positioned adjacent to the outer periphery.

19. The assembly according to claim 18, wherein the ground engaging wheels are positioned beyond the bottom surface of the receptacle.
